(19) United States
(12) Patent Application Publication
(10) Pub. No.: US 2003/0185369 A1
(43) Pub. Date: Oct. 2, 2003

(54) Telephone conference bridge provided via a plurality of computer telephony resource algorithms

(76) Inventors: Neal C. Oliver, Florham Park, NJ (US); Amin F. Rhemtulla, Randolph, NJ (US)

Correspondence Address: BUCKLEY, MASCHOFF, TALWALKAR, & ALLISON, 5 ELM STREET, NEW CANAAN, CT, 06840, US

(21) Appl. No.: 10/112,194

(22) Filed: Mar. 29, 2002

(51) Int. Cl. H04M 3/42

(52) U.S. Cl. 379/202.01

(57) ABSTRACT

According to some embodiments, a telephone conference bridge is provided via a plurality of computer telephone resource algorithms.

### BACKGROUND

A conference call bridge lets a multiple people participate in a telephone conference call. For example, each person who wants to participate in a conference call may use his or her telephone to call a conference bridge. The conference bridge arranges for the participants to speak and listen to each other by performing a mathematical mixture of input audio streams (e.g., received from the participants) and generating one or more output audio streams (e.g., to be provided to the participants). For example, the conference bridge may combine the input audio streams to generate a summed output audio stream.

In addition to simply combining the input streams, a conference bridge can provide a number of other features for a conference call. For example, a conference bridge may provide echo cancellation to facilitate the use of speakerphones. A conference bridge may also receive a command from a participant via Dual Tone Multi-Frequency (DTMF) signals. For example, a participant might press “*6” on his or her telephone keypad to activate a mute function. In this case, the conference bridge can also prevent other participants from hearing the DTMF signals. As still another example, a conference bridge may analyze input audio streams to identify participants who are currently speaking (e.g., and reduce background noise by only combining input streams received from those participants).

A conference bridge is typically designed to provide these, and other, functions by implementing tightly coupled modules of Digital Signal Processing (DSP) code to perform the algorithms associated with the desired functions. The DSP code is customized to fit within the processor cycle, memory, and/or bandwidth budget of a single DSP device or a limited, pre-determined number of DSP devices. To fit within these constraints, the DSP code is written by experts who understand the complex mathematics behind the algorithms, as well as the computer resources associated with the particular conference bridge hardware. As a result, designing a conference bridge can be a difficult, expensive, and time consuming task.

Moreover, the functions and capabilities of a conference bridge cannot be dynamically adjusted once the design is complete. For example, a system designed to provide a conference bridge for a maximum of ten participants cannot be dynamically adjusted to handle a conference call for twelve participants. Similarly, resources will be wasted if only a small number of participants are using a system that was designed to provide a conference bridge for a larger number of participants. That is, the computing resources that were pre-allocated to support the larger number of participants cannot be shared with other tasks in the system (e.g., tasks associated with other conference calls).

### BRIEF DESCRIPTION OF THE DRAWINGS

FIG. 1 is a block diagram of a communication system according to some embodiments.

FIG. 2 is a block diagram of a communication controller according to some embodiments.

FIG. 3 is a flow chart of a method of facilitating communication according to some embodiments.

FIG. 4 is a resource diagram of a communication system according to some embodiments.

FIG. 5 is a tabular representation of a portion of a conference bridge database according to one embodiment.

FIG. 6 is a flow chart of a computer-implemented method according to one embodiment.

FIG. 7 is a resource diagram of a telephone conference bridge according to one embodiment.

### DETAILED DESCRIPTION

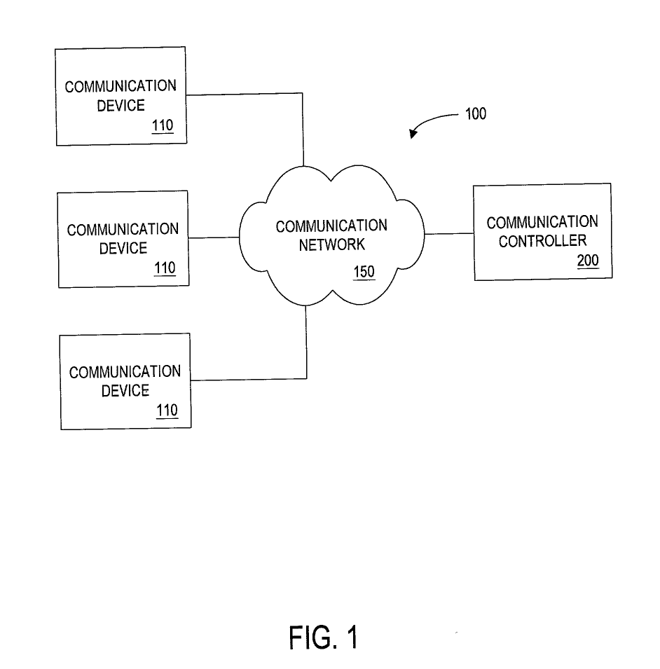

Turning now in detail to the drawings, FIG. 1 is a block diagram of a communication system 100 according to some embodiments. The communication system 100 includes a communication controller 200 that exchanges information with a number of communication devices 110 via a communication network 150.

As used herein, the phrase “communication device” can refer to any device that lets a person exchange information with another person via a communication network. Examples of communication devices 110 include wired or wireless telephones, computers adapted to provide telephone communication, and hardware units (e.g., boards) or software applications that enable a computer to provide telephone communication. For example, a communication device 110 may be a Personal Computer (PC) with one or more INTEL® DIALOGIC® telecom boards that incorporate Interactive Voice Response (IVR) capabilities.

The communication network 150 may comprise, for example, a telephone network such as a Public Switched Telephone Network (PSTN), a wireless network, or a network associated with a Private Branch Exchange (PBX) device. The communication network 150 may also comprise a Local Area Network (LAN), a Metropolitan Area Network (MAN), a Wide Area Network (WAN), a proprietary network, a Wireless Application Protocol (WAP) network, and/or an Internet Protocol (IP) network such as the Internet, an intranet or an extranet. Note that the communication network 150 may include a number of different networks.

According to some embodiments, the communication controller 200 is adapted to provide a conference bridge that lets multiple people participate in a telephone conference call. For example, three people may each place a telephone call to the communication controller 200 via different communication devices 110. The communication controller 200 can then arrange for those people to participate in a conference call. The communication controller 200 may be implemented by, for example, a CT server, a PBX, or a public switch. It may be associated with a product, such as the INTEL® Converged Communications Platform, or be deployed as part of a service (e.g., an AT&T® conference call service). Note that although a single communication controller 200 is shown in FIG. 1, any number of communication controllers 200 may be included in the communication system 100.

Communication Controller

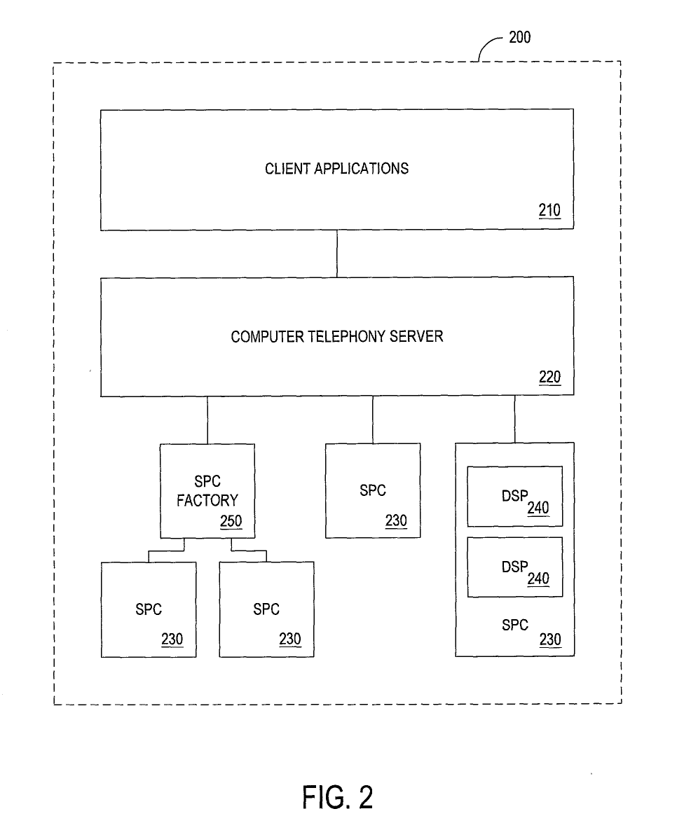

FIG. 2 illustrates a communication controller 200 that is descriptive of the device shown, for example, in FIG. 1 according to some embodiments. The communication controller 200 may include a processor, such as one or more INTEL® PENTIUM® processors, and at least one communication port adapted to exchange information with other devices (e.g., communication devices 110 or other communication controllers 200). A communication port may, for example, receive audio streams from communication devices 110 via analog lines or digital lines (e.g., a T1 line).

The communication controller 200 may also include an information storage device, including combinations of magnetic storage devices (e.g., magnetic tape and hard disk drives), optical storage devices, and/or semiconductor memory devices such as Random Access Memory (RAM) devices and Read Only Memory (ROM) devices. The storage device may store one or more programs for controlling the processor. The processor performs instructions of the program.

For example, the processor may execute one or more client applications 210. Such a client application 210 may perform a media function (e.g., a telephone conference bridge function) via a vendor-neutral Application Protocol Interface (API). Note that a client application 210 may be associated with the Enterprise Computer Telephony Forum (ECTF) S.100 Media and Switching Services Interface Revision 2.0 published 1998, the ECTF S.410 Media Services for JAVA™ Revision 2.0 published 2001, the voice Extensible Markup Language (XML), the C programming language, and/or the JAVA™ programming language.

As shown in FIG. 2, a client application 210 may communicate with a CT server 220. For example, a client application 210 may communicate with the CT server 220 via a wire-level protocol, such as the ECTF S.200 Transport Protocol Interface ratified in 1997.

The CT server 220 in turn communicates with a number of Signal Processing Components (SPCs) 230. The SPCs 230 may be associated with, for example, blocks of code and/or hardware that perform resource algorithms (e.g., associated with media operations such as echo cancellation or speech recognition). An SPC 230 may, for example, execute: (i) in a runtime environment that differs from a normal application, (ii) in a kernel mode rather than a user mode, (iii) in a real-time operating system environment, and/or (iv) on an external embedded system distinct from the environment in which the CT server 220 executes. Also note that it may be possible to create new resource instances dynamically at runtime, or less dynamically when a system is reset. According to some embodiments, a resource algorithm may be statically allocated to a special-purpose hardware component.

An SPC 230 may include one or more DSP circuits 240, such as an Application-Specific Integrated Circuit (ASIC) or a Programmable Read Only Memory (PROM) device. Moreover, the SPCs 230 may be connected to different switch fabrics. For example, SPCs 230 may be connected to a Time-Division Multiplexing (TDM) bus, such as a bus conformant with the ECTF H.100 Hardware Compatibility Specification Revision 1.0 (1997), an Asynchronous Transfer Mode (ATM) circuit, and/or a Real-time Transport Protocol (RTP) circuit.

The CT server 220 may communicate directly with an SPC 230. According to some embodiments, an SPC 230 is managed by an SPC factory 250 that initializes and configures any hardware or software associated with the SPC 230, supplies SPC registration information that describes the SPC 230 to the CT server 220, and/or creates the SPC 230 on demand. Note that a single SPC factory 250 could be associated with one or more SPCs 230.

The CT server 220 may communicate with the SPCs 230, for example, via the ECTF S.300 Media Services Provider Interface Specification currently under development. In general, the ECTF architecture includes a CT server 220 that configures media and network interface resources from multiple vendors into a group that is handed-off to a client application 210. The client application 210 can then invoke services on the group via a vendor-independent API. The S.300 specification defines a control-plane interface that lets the CT server 220 control the resource algorithms implemented by the SPCs 230.

For example, an SPC factory 250 may transmit registration information to the CT server 220 describing capabilities of the resources implemented by one or more SPCs 230. The CT server 220 may then dynamically construct a conference bridge using some or all of the available SPCs 230 (which may be associated with different SPC factories 250).

Each SPC 230 may include ports (e.g., input and output ports) through which resource algorithms can be interconnected via a switch fabric. In this case, the CT server 220 may construct the conference bridge by connecting output ports associated with some SPCs 230 to input ports associated with other SPCs 230 as appropriate. The CT server 220 may also transmit information to the SPC factory 250 to reserve the SPCs 230 as required for the conference bridge. In this way, SPCs 230 that are not currently needed for the conference bridge are available to be used for other purposes (e.g., by other client applications 210).

Note that the client applications 210, the CT server 220, and/or the SPCs 230 may be associated with, for example: (i) a single processor, (ii) multiple CT boards within a single PC (e.g., that communicate via an H.100 isochronous bus), and/or (iii) separate devices.

Moreover, as used herein, information may be “received” by or “transmitted” to a software application or module within the communication controller 200 from: (i) a communication device 110, (ii) another software application or module within the communication controller 200, or (iii) any other source.

Conference Bridge Method

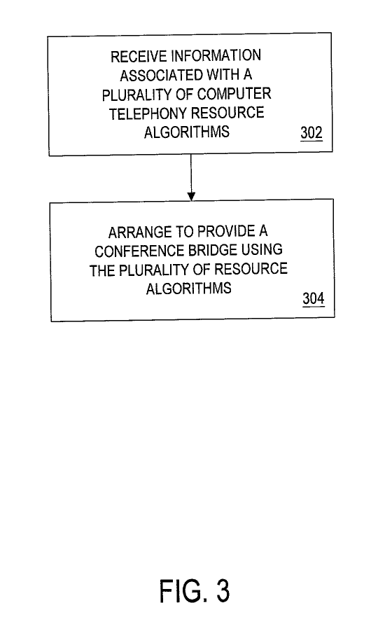

FIG. 3 is a flow chart of a method of facilitating communication that may be performed, for example, by the communication controller 200 shown in FIGS. 1 and 2 according to some embodiments. The flow charts in FIG. 3 and the other figures described herein do not imply a fixed order to the steps, and embodiments can be practiced in any order that is practicable.

At 302, information associated with a plurality of CT resource algorithms is received. A resource algorithm may, for example, receive one or more media streams via input ports, process the media streams, and provide one or more media streams via output ports.

For example, a resource algorithm may be an echo cancellation algorithm that facilitates the use of speakerphones during a conference call. Similarly, a resource algorithm may be a self-cancellation algorithm that prevents a participant from hearing his or her own voice when speaking during a conference call.

As another example, a resource algorithm may detect DTMF tones in a media stream (perhaps entered by a conference bridge user by pushing buttons on a telephone keypad), interpret the tones as a command (e.g., to “mute” his or her conference call leg), and/or filter the tones from the media stream so that they will not be “heard” by other resources.

Other examples of resource algorithms include an Automatic Gain Control (AGC) algorithm (e.g., to control the volume of a conference call leg), a speech level algorithm (e.g., to identify participants who are currently speaking), and a summing algorithm (e.g., to combine input streams received from different conference call participants).

The information received at 302 may include, for example, registration information received from an SPC 230 (or an SPC factory 250) that describes the capabilities of a resource algorithm.

At 304, it is arranged to provide a conference bridge using the plurality of resource algorithms. The conference bridge may, for example, enable communication between a plurality of call channel resources (e.g., attachment points of conference call media streams). By way of example, the CT server 210 may arrange to provide a conference bridge for a client application 210 via a control plane service provider interface and a distributed processing network.

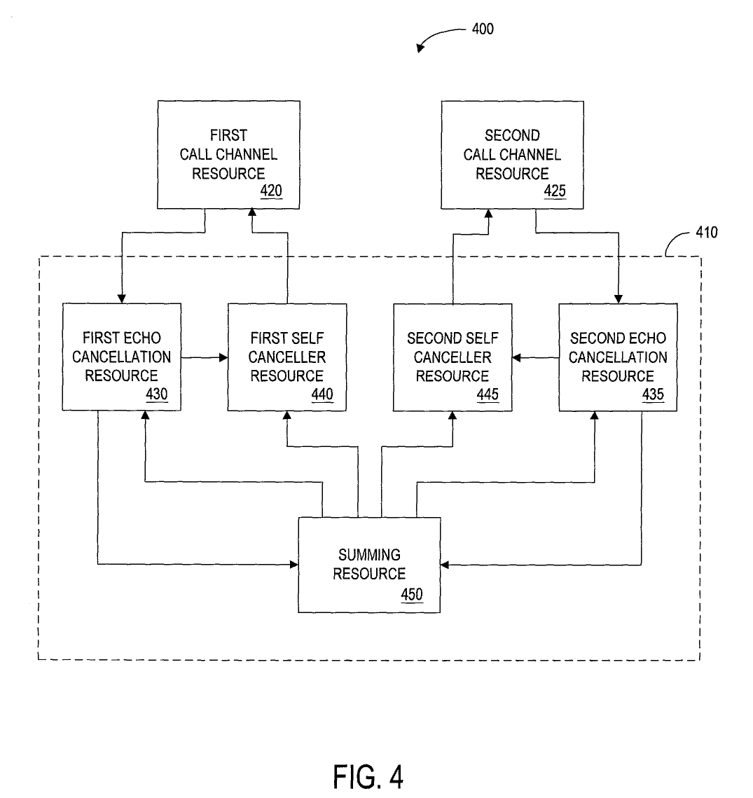

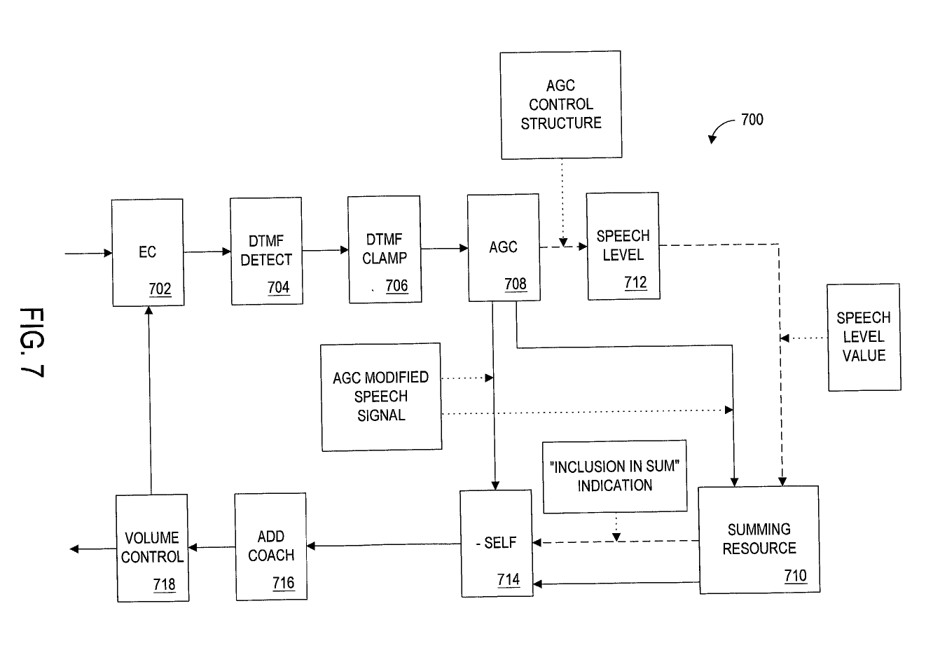

According to one embodiment, the CT server 220 transmits reservation information to the resource algorithms (or to associated SPC factories 250) and dynamically constructs the conference bridge via a resource graph that includes the resource algorithms. For example, the CT server 220 may define interconnections between the resource algorithms to create the resource graph (e.g., by connecting an output port of a first resource algorithm to an input port of a second resource algorithm). Examples of resource graphs are described with respect to FIGS. 4 and 7.

According to some embodiments, the conference bridge can be dynamically adjusted. For example, the CT server 220 may dynamically adjust a conference bridge (e.g., in response to a request from a client application 210) by removing resource algorithms from, or adding resource algorithms to, the conference bridge. Consider a communication controller 200 that has access to thirty ten-port conference bridges. When fifteen people participate in a conference call, the CT server 220 may dynamically assemble a conference bridge, for example, by either (i) growing a ten port bridge by adding resources or (ii) releasing resources from a ten port bridge (e.g., to perform other CT functions or to assemble other conference bridges) and thereby connect a ten port and a five port bridge.

Resource Diagram

FIG. 4 is a resource diagram of a communication system 400 according to one embodiment. In particular, the communication system 400 includes two call channel resources 420, 425 (e.g., each associated with a telephone conference call participant) in communication with a “simple” conference bridge 410 (i.e., the conference bridge 410 illustrated in FIG. 4 does not include many functions that are commonly associated with conference calls). The call channel resources 420, 425 may be associated with, for example, a wired or wireless telephone connection. Of course, the conference bridge 410 may communicate with any number of call channel resources 420, 425.

The conference bridge 410 includes an echo cancellation resource 430, 435 for each call channel resource 420, 425. The echo cancellation resources 430, 450 may remove acoustic echo from each call leg to facilitate the use of speakerphones. For example, the raw input to the first echo cancellation resource 430 comes from the first call channel resource 420 while the reference input is received from a summing resource 450.

The conference bridge 410 also includes a self canceller resource 440, 445 for each call channel resource 420, 425. The self canceller resources 440, 445 may remove the signal created by a participant from a media stream (e.g., so the participant does not hear his or her own voice). For example, the first self canceller resource 440 receives: (i) a summed signal as an input from the summing resource 440 and (ii) the participant's echoless media stream as a reference input from the first echo cancellation resource 430.

The conference bridge 410 also includes a summing resource 450 that combines information received from the echo cancellation resources 430, 435. The summing resource 450 provides the combined media stream back to the echo cancellation resources 430, 435 as well as to the self canceller resources 440, 445.

As can be seem, the overall media stream processing of the conference bridge 410 is represented and defined as a resource graph (e.g., a filter graph or a directed graph), where the nodes in the graph are resource algorithms that consume quantities of data from input media streams, process them, and produce quantities of data to output media streams. The interconnections between these algorithms may represent circuits that carry the media streams. The resource graph may be deployed, for example, by implementing executable code corresponding to the resource algorithms and deploying the code onto processors that are interconnected by a switch fabric.

As a result, the overall media stream processing of the conference bridge 410 may be distributed among the processors of a distributed processing network. For example, different nodes may be associated with different SPCs 230. In this way, the conference bridge 410 may be scaled by interconnecting additional nodes in the resource graph (and perhaps adding additional hardware on which the nodes execute) instead of changing the source code.

Although some embodiments have been described herein using ECTF specifications, a resource graph may be implemented using other protocols, such as those associated with the MICROSOFT® DIRECTSHOW® API, the INTEL® RMS2® architecture, and the PTOLEMY project associated with the University of California at Berkeley.

Conference Bridge Database

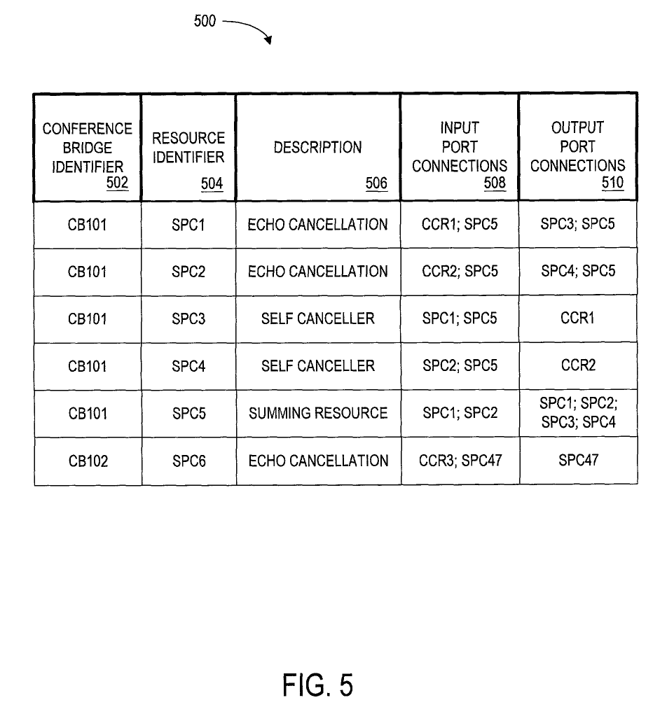

Referring to FIG. 5, a table represents a conference bridge database 500 that may be stored at the communication controller 200 according to one embodiment. The illustration and accompanying description of the database presented herein is exemplary, and any number of other database arrangements could be employed besides those suggested by the figure. The table includes entries defining one or more conference bridges. The table also defines fields 502, 504, 506, 508, 510 for each of the entries. The fields specify: a conference bridge identifier 502, a resource identifier 504, a description 506, input port connections 508, and output port connections 510. The information in the conference bridge database 500 may be created and updated, for example, based on information received from communication devices 110, SPCs 230, and/or SPC factories 250.

The conference bridge identifier 502 may be, for example, an alphanumeric code associated with a conference bridge that has been (or will be) provided for a telephone conference call.

The resource identifier 504 may be, for example, an alphanumeric code associated with a resource algorithm implemented by a particular SPC and assigned to the conference bridge. The description 506 may define the capabilities associated with the resource identifier. The resource identifier 504 and description 506 may represent, for example, an SPC 230.

The input port connections 508 define where the resource algorithm's input ports are connected (e.g., to one or more output ports associated with other resource algorithms). Similarly, the output port connections 510 define where the resource algorithm's output ports are connected (e.g., to one or more input ports associated with other resource algorithms).

By way of example, the first five entries in the conference bridge database 500 are associated with the conference bridge 410 illustrated in FIG. 4. In particular, the entries are associated with the first and second echo cancellation resources 430, 435, the first and second self canceller resources 440, 445, and the summing resource 450, respectively. As can be seen, the third entry defines that the first self canceller resource 440 (i) receives input streams from the first echo cancellation resource 430 and the summing resource 450 and (ii) provides an output stream to'the first call channel resource 420.

### EXAMPLE

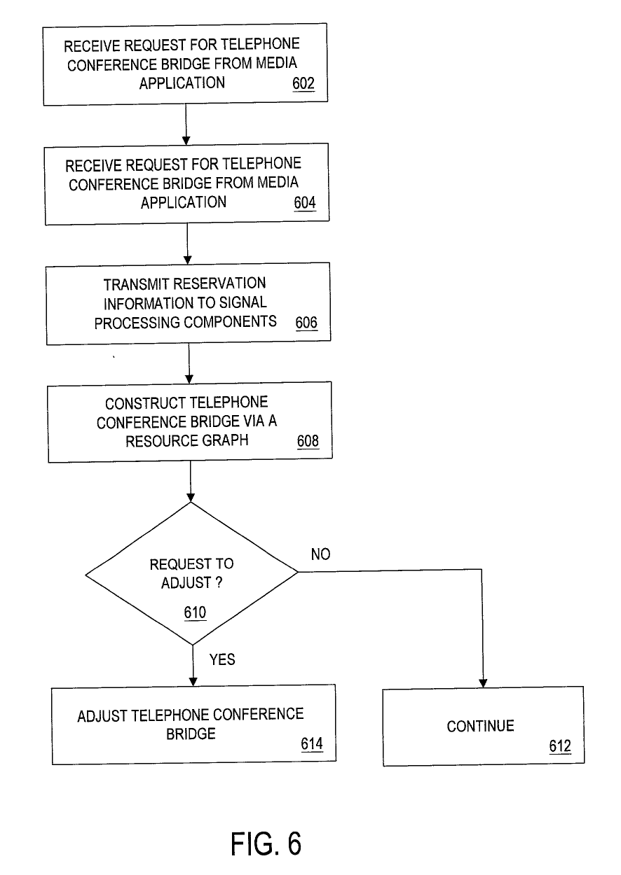

FIG. 6 is a flow chart of one example of computer-implemented method according to one embodiment. At 602, registration information associated with a plurality of SPCs 230 is received. For example, a CT server 220 may receive registration information from the SPCs 230 or the SPC factories 250. The registration information may indicate, for example, that an SPC 230 is associated with an echo or self-cancellation resource, a DTMF detection or clamping resource, an AGC resource, a speech level resource, an active speaker detection resource, a volume control resource, or a summing resource. The CT server 220 may also store resource identifiers 504 and descriptions 506 in the conference bridge database 500 as appropriate.

At 604, a request for a telephone conference bridge is received from a media application. For example, the CT server 220 may receive a request for a telephone conference bridge from a client application 210. The CT server 220 may also assign a conference bridge identifier 502 to the request.

Reservation information is transmitted to the SPCs at 606. For example, the CT server 220 may transmit the reservation information to SPCs 230 or the SPC factories 250.

At 608, the telephone conference bridge is constructed via a resource graph by defining interconnections between the SPCs 230. The CT server 220 may also store the appropriate input port connections 508 and output port connections 510 in the conference bridge database 500.

It is then determined at 610 whether or not the media application has requested an adjustment to the telephone conference bridge. If the media application has not requested an adjustment at 610, the process continues providing the existing conference bridge at 612.

If the media application has requested an adjustment at 610, the telephone conference bridge is adjusted at 614 based on information received from the media application. For example, the CT server 220 may update the conference bridge database 500 to reflect newly deleted or added SPCs 230 and/or interconnections between SPCs 230.

FIG. 7 is a resource diagram of a telephone conference bridge 700 according to one embodiment. To facilitate understanding of this embodiment, only a single call leg is illustrated in FIG. 7.

As can be seen, an Echo Cancellation (EC) resource 702 receives a media stream associated with a conference call participant. The output of the EC resource 702 is provided to a DTMF detection resource 704 that may detect if the participant is issuing commands using DTMF signals. Any such DTMF signals are then removed by a DTMF clamping resource 706 before the media stream is provided to an AGC resource 708 that may (e.g., to adjust the volume of the media stream on a per-participant basis).

The media stream is then passed to a summing resource 710 that combine the stream with those from other participants in the conference call. The AGC resource 708 may also provide an AGC control structure signal (e.g., pre-computed as a side effect of the AGC process) to a speech level resource 712. The speech level resource 712 can use this information to generate and provide a speech level value to the summing resource 710 (e.g., using a relative sound level to determine if the participant is currently speaking). In this way, the summing resource 710 can determine whether or not the media stream received from the AGC resource 708 should be combined with other streams (e.g., only media streams associated with the four most active participants might be combined).

The summing resource 710 provides the combined media stream to a self canceller resource (i.e., “-self”) 714 along with an indication of whether or not the participant's voice is included in the combined stream. The self canceller resource 714 also receives the original (i.e., uncombined) media stream from the AGC resource 708. If the participant's voice is included in the combined stream, the self canceller resource 714 may remove it (e.g., so that the participant will not hear his or her own voice when speaking).

The media stream may then be provided to an add coach resource 716. According to some embodiments, a first participant in a conference call may be designated as a “coach” while another participant is designated as a pupil. In this case, the add coach resource 716 may add the voice of the coach to the pupil's media stream (e.g., to facilitate training of a telemarketer salesperson by his or her supervisor). Finally, a volume control resource 718 adjusts the volume of the media stream which is then output for the participant.

Thus, a telephone conference bridge with a variety of features can be provided via a resource graph's interconnected components. The components may comprise, for example, executable code for processing media streams and may be directly realized in hardware and software. The interconnections between the components may represent, for example, a physical connection between two different processors (e.g., a bus between two servers) or a buffer exchanging information within a processor. The interconnection may also be associated with, for example: (i) an H.100 bus, (ii) an IP packet flow, and/or (iii) International Telecommunication Union (ITU) G.711, G.723, or G.729 standards.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

In many of the embodiments described herein, a CT server 220 combines resource algorithms to create a conference bridge. According to another embodiment, however, an SPC factory 250 instead performs this function. For example, a client application 210 may transmit a request for a conference bridge to the CT server 220. In response, the CT server 220 may simply transmit a request for a conference bridge to an SPC factory 250. The SPC factory 250 can then combine resource algorithms associated with SPCs 230 to create the conference bridge for the CT server 220 (and the client application 210).

In addition, although particular CT resource algorithms have been described herein, the present invention may utilize any number of other resources algorithms. For example, a “coach” resource algorithm may let a participant may be heard only by a designated “pupil.” As another example, a “speaker identifier” resource may listen to a speaker and compare his or her voice to a pre-stored template in order to determine if the speaker is authorized to participate in a conference call.

Moreover, although some embodiments described herein are directed to telephone communication, the present invention can be used with any other type of communication. For example, a video conference server may utilize a number of interconnected video resource algorithms.

The several embodiments described herein are solely for the purpose of illustration. Persons skilled in the art will recognize from this description other embodiments may be practiced with modifications and alterations limited only by the claims.

What is claimed is:

1. A method of facilitating communication, comprising:
receiving information associated with a plurality of computer telephony resource algorithms; and
arranging to provide a conference bridge using the plurality of resource algorithms.

2. The method of claim 1, wherein said receiving and arranging are performed by a computer telephony server.

3. The method of claim 1, wherein the conference bridge enables communication between a plurality of call channel resources.

4. The method of claim 1, wherein the conference bridge is provided via a distributed processing network.

5. The method of claim 1, further comprising:
dynamically adjusting the conference bridge via at least one of: (i) removing resource algorithms, and (ii) adding resource algorithms.

6. The method of claim 1, wherein at least one of the plurality of resource algorithms is associated with at least one of: (i) an echo cancellation algorithm, (ii) a self-cancellation algorithm, (iii) a dual tone multi-frequency detection algorithm, (iv) a dual tone multi-frequency clamping algorithm, (v) an automatic gain control algorithm, (vi) a speech level algorithm, (vii) an active speaker detection algorithm, (viii) a volume control algorithm, and (ix) a summing algorithm.

7. The method of claim 1, wherein the received information includes registration information.

8. The method of claim 1, wherein said receiving comprises receiving the information from at least one of: (i) a signal processing component and (ii) a signal processing component factory.

9. The method of claim 1, wherein said arranging comprises:
transmitting reservation information to the plurality of resource algorithms; and
dynamically constructing the conference bridge via a resource graph including the plurality of resource algorithms.

10. The method of claim 9, wherein said constructing comprises defining interconnections between the plurality of resource algorithms to create the resource graph.

11. The method of claim 10, wherein the interconnections indicate that an output port of a first resource algorithm provides a media stream to an input port of a second resource algorithm.

12. The method of claim 1, wherein said arranging is performed for a media application via a control plane service provider interface.

13. The method of claim 1, wherein said receiving and arranging are performed by a signal processing component factory.

14. An apparatus, comprising:
a processor; and
a storage device adapted to communicate with said processor and storing instructions adapted to be executed by said processor to:
receiving information associated with a plurality of computer telephony resource algorithms, and
arrange to provide a conference bridge using the plurality of resource algorithms.

15. The apparatus of claim 14, wherein said processor is further adapted to communicate with at least one of: (i) a communication device, (ii) a communication controller, (iii) a call channel resource, (iv) a client application, (v) a computer telephony server, (vi) a signal processing component, and (vii) a signal processing component factory.

16. The apparatus of claim 14, wherein the processor dynamically constructs the conference bridge via a resource graph including the plurality of resource algorithms.

17. A medium storing instructions adapted to be executed by a processor to perform a method of facilitating communication, said method comprising:
receiving information associated with a plurality of computer telephony resource algorithms; and
arranging to provide a conference bridge using the plurality of resource algorithms.

18. The medium of claim 17, wherein said arranging comprises dynamically constructing the conference bridge via a resource graph including the plurality of resource algorithms.

19. A computer-implemented method of facilitating telephone communication, comprising:
receiving from a media application a request for a telephone conference bridge;
receiving registration information associated with a plurality of signal processing components;
transmitting reservation information to the signal processing components;
constructing the telephone conference bridge via a resource graph by defining interconnections between the signal processing components; and
adjusting the telephone conference bridge based on information received from the media application.

20. The method of claim 19, wherein at least one signal processing component is associated with at least one of: (i) an echo cancellation resource, (ii) a self-cancellation resource, (iii) a dual tone multi-frequency detection resource, (iv) a dual tone multifrequency clamping resource, (v) an automatic gain control resource, (vi) a speech level resource, (vii) an active speaker detection resource, (viii) a volume control resource, and (ix) a summing resource.
